(19) United States
(12) Patent Application Publication
(10) Pub. No.: US 2007/0281199 A1
(43) Pub. Date: Dec. 6, 2007

(54) CROSSLINKED MEMBRANE ELECTRODE ASSEMBLIES

(76) Inventor: ROBERT D. LOUSENBERG, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/755,839

(22) Filed: May 31, 2007

Related U.S. Application Data
(60) Provisional application No. 60/810,096, filed on Jun. 1, 2006.

(51) Int. Cl. H01M 8/10; H01M 4/94

(52) U.S. Cl. 429/33; 429/44

(57) ABSTRACT

Described are membrane electrode assemblies and electrochemical cells, containing crosslinked membranes and electrodes, which membranes and electrodes are prepared from fluoropolymer organic-liquid dispersions.

This application claims the benefit of U.S. Provisional Application No. 60/810,096 filed Jun. 1, 2006.

### FIELD OF INVENTION

The invention is directed to membrane electrode assemblies that include crosslinked membranes and electrodes, which membranes and electrodes are prepared from fluoropolymer organic-liquid dispersions.

### BACKGROUND

Electrochemical cells generally include an anode electrode and a cathode electrode separated by an electrolyte. Fuel cells are electrochemical cells that convert the chemical energy of a fuel, such as a hydrogen gas, and an oxidant, such as air, into electrical energy. Fuel cells are typically formed as stacks or assemblages of membrane electrode assemblies (MEAs), which each include an electrolyte, an anode (a negatively charged electrode) and cathode (a positively charged electrode), and other optional components. A polymeric proton exchange membrane (PEM) is frequently used as the electrolyte. A metal catalyst and electrolyte mixture is generally used to form the anode and cathode electrodes. Fuel cells typically also comprise a porous electrically conductive sheet material that is in electrical contact with each of the electrodes and permits diffusion of the reactants to the electrodes, and is know as a gas diffusion layer, gas diffusion substrate or gas diffusion backing. When the electrocatalyst is coated on or adhered to the PEM, the MEA is said to include a catalyst coated membrane (CCM). In other instances, where the electrocatalyst is coated on the gas diffusion layer, the MEA is said to include gas diffusion electrode(s) (GDE). The functional components of fuel cells are normally aligned in layers as follows: conductive plate/gas diffusion backing/anode electrode/membrane/cathode electrode/gas diffusion backing/conductive plate. In a fuel cell, a reactant or reducing fluid such as hydrogen or methanol is supplied to the anode, and an oxidant such as oxygen or air is supplied to the cathode. The reducing fluid electrochemically reacts at a surface of the anode to produce hydrogen ions and electrons. The electrons are conducted to an external load circuit and then returned to the cathode, while hydrogen ions transfer through the electrolyte to the cathode, where they react with the oxidant and electrons to produce water and release thermal energy.

Long term MEA stability is critically important for fuels cells. MEA stability depends on the stability of the PEM, the anode and cathode electrodes, and the engagement between the PEM and the electrodes. One mechanism that has been used to improve membrane stability has been to provide cross-links within the body of the membrane. However, when the PEM is highly crosslinked, it becomes difficult to make CCMs in which the electrodes fully engage the membrane and remain physically and chemically engaged over the life of the MEA. This is especially the case when the electrodes are prepared as decals that are transferred to the surface of the membrane to produce a CCM.

Solvent or dispersion casting is a common and advantageous fuel cell membrane fabrication process. Well-known fluoropolymer electrolyte dispersions that are in widespread commercial use are Nafion® perfluoroionomers available from E. I. du Pont de Nemours and Company, Wilmington Del. The solutions and dispersions used to form the membranes are also frequently used to make catalyst ink formulations that are used to form the electrodes of the fuel cell MEA. Fluoropolymer electrolyte dispersions suitable for casting membranes are disclosed in U.S. Pat. Nos. 4,433,082 and 4,731,263, which teach aqueous organic and organic-liquid fluoropolymer electrolyte dispersion compositions in sulfonic acid (SO₃H) and sulfonate (SO₃⁻) form with no significant sulfonyl fluoride (SO₂F) concentrations. MEA electrodes made from such fluoropolymer electrolyte dispersions and a variety of catalysts are disclosed in WO2005/001978.

U.S. Pat. No. 3,282,875 discloses that the SO₂F group of a precursor fluoropolymer electrolyte might be used to crosslink or “vulcanize” the fluoropolymer by reaction with di- or multifunctional crosslinking agents but did not disclose a method to do this homogeneously or a way to securely attach electrodes to membranes comprised of a crosslinked fluoropolymer. US2005/0124769 discloses functionalized aromatic main chain polymers useful in membranes and electrodes that can be crosslinked. U.S. Pat. No. 6,733,914 discloses a method for heterogeneously converting a significant fraction of the SO₂F groups of Nafion®-like polymer membranes to SO₃⁻ and sulfonamide (SO₂NH₂) groups by reaction with aqueous ammonia. The membranes were subsequently crosslinked by a heat-annealing step at high temperature in which some of the SO₂NH₂ groups presumably reacted with residual the SO₂F groups to form sulfonimide (—SO₂NHSO₂—) crosslinks. The heterogeneous nature of the front reaction with aqueous ammonia did not provide a homogeneous crosslink density throughout the film and there is no disclosure of a way to securely attach electrodes to membranes comprised of a crosslinked fluoropolymer. There remains a need for durable MEAs that include a fluoropolymer membrane and fluoropolymer-based electrodes securely engaged to the membrane.

### SUMMARY

The invention is directed to a membrane electrode assembly comprising:
a) a proton exchange membrane comprised of a first polymer having a fluorinated backbone containing pendant groups described by the formula —(O—CF₂CFR_{f})ₐ—(O—CF₂)_{b}—(CFR′_{f})_{c}SO₂X, where X is a halogen, an —OH or salt thereof, and R_{f} and R′_{f} are independently selected from F, Cl or a perfluorinated alkyl group having 1 to 10 carbon atoms, a=0 to 2, b=0 to 1, and c=0 to 6; and
b) an electrode comprised of an electrocatalyst and a second polymer having a fluorinated backbone containing pendant groups described by the formula —(O—CF₂CFR_{f})ₐ—(O—CF₂)_{b}—(CFR′_{f})_{c}SO₂X, where X is a halogen, an —OH or salt thereof, and R_{f} and R′_{f} are independently selected from F, Cl or a perfluorinated alkyl group having 1 to 10 carbon atoms, a=0 to 2, b=0 to 1, and c=0 to 6, wherein the electrode is positioned against the membrane and is crosslinked to the membrane.

In a preferred embodiment of the invention, there are crosslinks between pendant groups of the first polymer in the membrane and pendant groups of the second polymer in the electrode. The crosslinks may comprise one or more sulfonimide moieties.

### DETAILED DESCRIPTION

Where a range of numerical values is recited herein, unless otherwise stated, the range is intended to include the endpoints thereof, and all integers and fractions within the range. It is not intended that the scope of the invention be limited to the specific values recited when defining a range. Moreover, all ranges set forth herein are intended to include not only the particular ranges specifically described, but also any combination of values therein, including the minimum and maximum values recited.

Membrane electrode assemblies made by the processes described herein, particularly when converted to ionomeric acid form, can be used in fuel cells. Examples include hydrogen fuel cells, reformed-hydrogen fuel cells, direct methanol fuel cells or other organic/air (e.g. those utilizing organic fuels of ethanol, propanol, dimethyl- or diethyl ethers, formic acid, carboxylic acid systems such as acetic acid, and the like). The membrane electrode assemblies can also be advantageously employed in other electrochemical cells. Other uses for the membrane electrode assemblies described herein include use in batteries and use in cells for the electrolysis of water to form hydrogen and oxygen.

The PEM is typically comprised of an ion exchange polymer, also known as an ionomer. Following the practice of the art, the term “ionomer” is used to refer to a polymeric material having a pendant group with a terminal ionic group. The terminal ionic group may be an acid or a salt thereof as might be encountered in an intermediate stage of fabrication or production of a fuel cell. Proper operation of an electrochemical cell may require that the ionomer be in acid form. Highly fluorinated ionomers are frequently used in PEMs. “Highly fluorinated” means that at least 90% of the total number of univalent atoms in the polymer are fluorine atoms. Most typically, the polymer of the PEM is perfluorinated, which means that 100% of the of univalent atoms in the polymer are fluorine atoms. It is typical for polymers used in fuel cell membranes to have sulfonate ion exchange groups. The term “sulfonate ion exchange groups” as used herein means either sulfonic acid groups or salts of sulfonic acid groups, typically alkali metal or ammonium salts.

MEAs typically include an anode electrode facing one side of the PEM and a cathode electrode facing the opposite side of the PEM. The anode and cathode electrodes are typically applied on or adhered to the PEM so as to form a CCM, which is sometimes referred to as an MEA3. In other MEA arrangements, one or both of the electrodes may be coated on or adhered to the PEM-facing side of gas diffusion layers positioned on opposite sides of the PEM. For the electrodes to function effectively in the fuel cells, effective anode and cathode electrocatalyst sites must be provided in the anode and cathode electrodes. In order for the anode and cathode to be effective: (1) the electrocatalyst sites must be accessible to the reactant, (2) the electrocatalyst sites must be electrically connected to the gas diffusion layer, and (3) the electrocatalyst sites must be ionically connected to the fuel cell electrolyte. The electrocatalyst sites are ionically connected to the electrolyte via an ionomer binder in the electrode. The binder employed in the electrode serves as a binder for the electrocatalyst particles and it help to physically and ionically connect the electrode to the membrane. It is therefore important that the ion-exchange polymers in the binder composition be compatible with the ion-exchange polymer in the membrane. Ionomers suitable for the binder of the anode and cathode electrodes of the MEAs of the invention are the fluorinated ion-exchange polymers, and most typically highly fluorinated polymers. These ionomers typically have end groups in sulfonyl halide form, but may alternatively have end groups in the sulfonic acid form.

The present invention is directed to the preparation of MEAs in which one or more of the electrodes is attached to the PEM and where chemical crosslinks are formed between the polymer of the PEM and the ionomer binder in at least one of the electrodes. In addition, in the MEAs prepared according to the invention, there are also crosslinks formed within the PEM. In the preferred method for producing MEAs, the ionomer of the PEM and the ionomer binder of an adjoining electrode are produced from polymer dispersions containing significant and homogeneously dispersed sulfonyl halide (SO₂X) groups in a non-fluorinated liquid. The method for producing the polymer dispersions comprises the steps of:
a) providing a solution comprising a polymer solvent and a polymer containing pendant SO₂X groups, wherein the polymer comprises a fluorinated backbone containing pendant groups described by the formula —(O—CF₂CFR_{f})ₐ—(O—CF₂)_{b}—(CFR′_{f})_{c}SO₂X, where X is a halogen, R_{f} and R′_{f} are independently selected from F, Cl or a perfluorinated alkyl group having 1 to 10 carbon atoms, a=0 to 2, b=0 to 1, and c=0 to 6;
b) combining the solution of step a) with a nucleophilic compound Y and a polar liquid, in any order, to form a reaction mixture; and
c) removing by distillation substantially all of the polymer solvent from the reaction mixture of step b) to form a dispersion wherein about 5% to about 95% of the pendant SO₂X groups have reacted with the nucleophilic compound Y and about 95% to about 5% of the pendant SO₂X groups remain unreacted.

The polymer may be a homopolymer or a copolymer of any configuration, such as a block or random copolymer. By “fluorinated backbone” it is meant that at least 80% of the total number of halogen and hydrogen atoms on the backbone of the polymer are fluorine atoms. The polymer backbone may also be perfluorinated, which means that 100% of the total number of halogen and hydrogen atoms on the backbone are fluorine atoms. One type of suitable polymer is a copolymer of a first fluorinated vinyl monomer and a second fluorinated vinyl monomer having one or more SO₂X groups. Possible first monomers include tetrafluoroethylene (TFE), hexafluoropropylene, vinylidine fluoride, trifluoroethylene, chlorotrifluoroethylene, perfluoroalkylvinyl ether, and mixtures thereof. Possible second monomers include a variety of fluorinated vinyl ethers with a SO₂X group. X can be any halogen or a combination of more than one halogen, and is typically F.

Suitable homopolymers and copolymers that are known in the art include those described in WO 2000/0024709 and U.S. Pat. No. 6,025,092. A suitable fluoropolymer that is commercially available is Nafion® fluoropolymer from E. I. du Pont de Nemours and Company, Wilmington Del. One type of Nafion® fluoropolymer is a copolymer of tetrafluoroethylene (TFE) with perfluoro(3,6-dioxa-4-methyl-7-octenesulfonyl fluoride) (PSEPVE), as disclosed in U.S. Pat. No. 3,282,875. Other suitable fluoropolymers are copolymers of TFE with perfluoro(3-oxa-4-pentenesulfonyl fluoride) (PSEVE), as disclosed in U.S. Pat. No. 4,358,545 and U.S. Pat. No. 4,940,525, and copolymers of TFE with CF2=CFO(CF₂)₄SO₂F, as disclosed in U.S. Patent Application 2004/0121210. The polymer may comprise a perfluorocarbon backbone and pendant groups of the formula —O—CF₂CF(CF₃)—O—CF₂CF₂SO₂F. Polymers of this type are disclosed in U.S. Pat. No. 3,282,875. All of these copolymers can be converted later to the ionomeric form by hydrolysis, typically by exposure to an appropriate aqueous base, as disclosed in U.S. Pat. No. 3,282,875.

The polymer is typically first dissolved in a solvent for the polymer at a concentration typically between 1 and 30% (weight % or w/w) and preferably between 10 and 20% (w/w). By “polymer solvent” is meant a solvent that will dissolve and solvate the SO₂X form of the polymer and not otherwise react with or degrade the polymer. Typically the polymer solvent is fluorinated. By “fluorinated” it is meant that at least 10% of the total number of hydrogen and halogen atoms in the solvent are fluorine. Examples of suitable polymer solvents include, but are not limited to, fluorocarbons (a compound containing only carbon and fluorine atoms), fluorocarbon ethers (a fluorocarbon additionally containing an ether linkage), hydrofluorocarbons (a compound containing only carbon, hydrogen and fluorine atoms), hydrofluorocarbon ethers (a hydrofluorocarbon additionally containing an ether linkage), chlorofluorocarbons (a compound containing only carbon, chlorine and fluorine atoms), chlorofluorocarbon ethers (a chlorofluorocarbon additionally containing an ether linkage), 2H-perfluoro(5-methyl-3,6-dioxanonane), and Fluorinert® electronic liquids (3M, St. Paul, Minn.). Suitable solvents also include fluorochemical solvents from E. I. DuPont de Nemours (Wilmington, Del.) A mixture of one or more different polymer solvents may also be used.

The SO₂X form polymer is dissolved with stirring and may require heating for efficient dissolution. The dissolution temperature may be dependent on the polymer composition or SO₂X concentration as measured by the equivalent weight (EW). For the purposes of this application, EW is defined to be the weight of the polymer in sulfonic acid form required to neutralize one equivalent of NaOH, in units of grams per mole (g mol⁻¹). High EW polymers (i.e. low SO₂X concentration) may require higher dissolution temperatures. When the maximum dissolution temperature at atmospheric pressure is limited by the boiling point of the solvent, a suitable pressure vessel may be used to increase the dissolution temperature. The polymer EW may be varied as desired for the particular application. Herein, polymers with EW less than or equal to 1500 g mol⁻¹ are typically employed, more typically less than about 900 g mol⁻¹.

Next, a reactive mixture is formed by mixing a nucleophilic compound, Y, and a polar liquid, with the polymer solution. The terms “nucleophilic” and “nucleophile” are recognized in the art as pertaining to a chemical moiety having a reactive pair of electrons. More specifically herein, the nucleophilic compound Y is capable of displacing the halogen X of the polymer SO₂X groups through a substitution type reaction, and forming a covalent bond with sulfur. Suitable nucleophilic compounds may include but are not limited to, water, alkali metal hydroxides, alcohols, amines, hydrocarbon and fluorocarbon sulfonamides. The amount of the nucleophilic compound Y added is generally less than stoichiometric and will determine the % of SO₂X groups that will remain unreacted.

By “polar liquid” it is meant any compound that is liquid at process conditions and refers to a single liquid or to a mixture of two or more polar liquids, wherein the liquid(s) have a dipole moment of about 1.5 debye units or higher, typically 2-5. More specifically, suitable polar liquids should be capable of solvating the nucleophile Y, the reacted form of Y with the polymer SO₂X groups, but not necessarily solvate the bulk polymer. Suitable polar liquids include, but are not limited to dimethylformamide (DMF), dimethylacetamide (DMAC), N-methylpyrrolidone (NMP), dimethyl sulfoxide (DMSO), acetonitrile, propylene carbonate, methanol, ethanol, water, or combinations thereof. Suitable polar liquids preferably have a boiling point higher than the solvent for the polymer.

The nucleophilic compound Y and polar liquid may be added to the polymer solution in any order. Typically, the nucleophile Y and some or all of the polar liquid are added simultaneously as a mixture to the polymer solution. Additional polar liquid or a different polar liquid may be added in a separate step. Other compounds may be added simultaneously or sequentially in any order with Y and the polar liquid. For example, when Y is water, non-nucleophilic bases can be added, such as but not limited to LiH, NaH, and NR⁴R⁵R⁶, wherein R⁴, R⁵ and R⁶ are optionally substituted alkyl or aryl groups. The polar liquid and the nucleophile Y may also be the same compound. In one example, when water is functioning as both polar liquid and the nucleophile Y, a non-nucleophilic base as described above may need to be present.

The nucleophilic compound and polar liquid are preferably added to the polymer solution with fast turbulent mixing and at a temperature close to the dissolution temperature. When the dissolution temperature is low, the polymer solution temperature can be increased, typically above 50° C., prior to addition of the nucleophilic compound Y and polar liquid. A suitable pressure vessel can be used to increase the polymer solution temperature if it is limited due to the boiling points of the solvent, nucleophile Y, or polar liquid. The reaction, in which the nucleophilic compound Y displaces the halogen X of the polymer SO₂X groups, is typically complete within 5 minutes to 2 hours following the addition of the nucleophile and polar liquid.

Next, the reaction mixture is distilled to remove substantially all of the polymer solvent from the mixture. The distillation is preferably done at atmospheric pressure but may be done under vacuum. The distillation is considered complete when the still pot temperature approaches the boiling point of the polar liquid or the polar liquid begins to distill. Trace amounts of the polymer solvent may remain after distillation. The distillation may be repeated one or more times, optionally with additional polar liquid as needed to adjust viscosity. The remaining reaction mixture will be in the form of a dispersion with about 5% to about 95% of the pendant SO₂X groups having reacted with the nucleophilic compound Y and about 95% to about 5% of the pendant SO₂X groups remaining unreacted. Preferably, about 25% to about 75% of the pendant SO₂X groups are reacted with the nucleophilic compound Y with about 75% to about 25% of the pendant SO₂X groups remaining unreacted. The dispersion may also be filtered to remove insolubles. By “dispersion” it is meant a physically stable, homogenous mixture of fine particles of the polymer in the solvent, i.e. a mixture that does not separate into separate phases.

As defined herein, a dispersion results when the polar liquid is a good solvent for the reacted form of the nucleophile Y with the polymer pendent SO₂X groups but not necessarily a solvent for the bulk polymer. The exact reacted form of the SO₂X group will depend on the nucleophile used. For example, when water in the presence of a non-nucleophilic base such as triethylamine (TEA) is used, the reacted form will be a triethylammonium sulfonate salt (SO₃-TEAH⁺). Typically the pendant group is converted to SO₃M, wherein M is a univalent cation.

In another embodiment of the invention, a compound of the formula HNR¹R² may be added to the reaction mixture of steps (b) and (c) referred to previously so that about 1% to about 100% of the remaining pendant SO₂X groups are converted to pendant SO₂NR¹R² groups, wherein R¹ and R² are independently hydrogen or optionally substituted alkyl or aryl groups. The amount of SO₂X groups that are converted can be controlled by the amount of compound of the formula HNR¹R² added to the reaction mixture. Suitable substituents include but are not limited to ether oxygens, halogens, and amine functionalities. Typically R¹ and R² are hydrogen, alkyl, or aryl hydrocarbon groups.

In another embodiment polymer dispersions used in making the membrane and electrode binder include one or more polar liquids and a polymer with a fluorinated backbone comprising about 5% to about 95% pendant groups, preferably about 25% to about 75%, described by the formula —(O—CF₂CFR_{f})ₐ—(O—CF₂)_{b}—(CFR′_{f})_{c}SO₂Q, and about 95% to about 5% pendant groups, preferably about 75% to about 25%, described by the formula —(O—CF₂CFR_{f})ₐ—(O—CF₂)_{b}—(CFR′_{f})_{c}SO₃M, where Q is a halogen or NR¹R², or mixture thereof, R¹ and R² are independently hydrogen or optionally substituted alkyl groups, R_{f} and R′_{f} are independently selected from F, Cl or a perfluorinated alkyl group having 1 to 10 carbon atoms, a=0 to 2, b=0 to 1, c=0 to 6, and M is hydrogen or one or more univalent cation. The polar liquid can be a mixture and can comprise at least one polar liquid as defined above, and can also comprise water.

The polymer dispersions can be formed into membranes or electrodes using conventional methods. The membrane thickness can be varied as desired for a particular electrochemical application. Typically, the membrane thickness is less than about 350 μm, more typically in the range of about 25 μm to about 175 μm. If desired, the membrane can be a laminate of two polymers such as two polymers having different EW. Such films can be made by laminating two membranes. Alternatively, one or both of the laminate components can be cast from solution or dispersion. When the membrane is a laminate, the chemical identities of the monomer units in the additional polymer can independently be the same as or different from the identities of the analogous monomer units of the first polymer. For the purposes of the present invention, the term “membrane,” a term of art in common use is synonymous with the terms “film” or “sheet” which are terms of art in more general usage but refer to the same articles.

The membrane may optionally include a porous support or reinforcement for the purposes of improving mechanical properties, for decreasing cost and/or other reasons. The porous support may be made from a wide range of materials, such as but not limited to non-woven or woven fabrics, using various weaves such as the plain weave, basket weave, leno weave, or others. The porous support may be made from glass, hydrocarbon polymers such as polyolefins, (e.g., polyethylene, polypropylene), perhalogenated polymers such as polychlorotrifluoroethylene. Porous inorganic or ceramic materials may also be used. For resistance to thermal and chemical degradation, the support preferably is made from a fluoropolymer, most preferably a perfluoropolymer. For example, the perfluoropolymer of the porous support can be a microporous film of polytetrafluoroethylene (PTFE) or a copolymer of tetrafluoroethylene with CF₂═CFCnF₂ₙ₊₁ (n=1 to 5) or (CF₂═CFO—(CF₂CF(CF₃)O)ₘCnF₂ₙ₊₁(m=0 to 15, n=1 to 15). Microporous PTFE films and sheeting are known which are suitable for use as a support layer. For example, U.S. Pat. No. 3,664,915 discloses uniaxially stretched film having at least 40% voids. U.S. Pat. Nos. 3,953,566, 3,962,153 and 4,187,390 disclose porous PTFE films having at least 70% voids.

The porous support or reinforcement may be incorporated by coating the polymer dispersions described above on the support so that the coating is on the outside surfaces as well as being distributed through the internal pores of the support. Alternately or in addition to impregnation, thin membranes can be laminated to one or both sides of the porous support. When the polar liquid dispersion is coated on a relatively non-polar support such as microporous PTFE film, a surfactant may be used to facilitate wetting and intimate contact between the dispersion and support. The support may be pre-treated with the surfactant prior to contact with the dispersion or may be added to the dispersion itself. Preferred surfactants are anionic fluorosurfactants such as Zonyl® from E. I. du Pont de Nemours and Company, Wilmington Del. A more preferred fluorosurfactant is the sulfonate salt of Zonyl® 1033D.

In order to form the anode or cathode electrodes of the MEA, an electrocatalyst is slurried with the dispersion of a fluorinated ion-exchange polymer as described. The slurry may further include an additional liquid component that may be the same as the polar liquid in the dispersion, a hydrophobic fluoropolymer, or any additional additives such as are commonly employed in the art may also be incorporated into the slurry. An electrocatalyst ink or paste is made by combining the electrocatalyst, the highly fluorinated ion-exchange polymer dispersion, and a suitable liquid medium. It is advantageous for the medium to have a sufficiently low boiling point that rapid drying of electrode layers is possible under the process conditions employed, provided however, that the composition does not dry so fast that the composition dries before transfer to the membrane. The liquid medium is typically polar for compatibility with the ion-exchange polymer, and is preferably able to wet the membrane.

A wide variety of polar organic liquids and mixtures thereof can serve as suitable additional liquid medium for the electrocatalyst coating ink or paste. Water or alcohols can be present in the medium if it does not interfere with the coating and subsequent crosslinking process steps. Although some polar organic liquids can swell the membrane when present in sufficiently large quantity, the amount of liquid used in the electrocatalyst coating is preferably small enough that the adverse effects from swelling during the process are minor or undetectable. It is believed that solvents able to swell the ion-exchange membrane can provide better contact and more secure application of the electrode to the membrane. Typical liquid mediums include dimethylformamide (DMF), dimethylacetamide (DMAC), N-methylpyrrolidone (NMP), dimethyl sulfoxide (DMSO), acetonitrile, propylene carbonate, methanol, ethanol, water, or combinations thereof. The amount of liquid medium used in the electrocatalyst coating ink or paste varies and is determined by the type of medium employed, the constituents of the electrocatalyst coating, the type of coating equipment employed, the desired electrode thickness, the process speeds, and other process conditions.

The resulting electrocatalyst paste or ink may then be coated onto an appropriate substrate for incorporation into an MEA. The method by which the coating is applied is not critical. Known electrocatalyst coating techniques can be used and produce a wide variety of applied layers of essentially any thickness ranging from very thick, e.g., 30 μm or more, to very thin, e.g., 1 μm or less. Typical manufacturing techniques involve the application of the electrocatalyst ink or paste onto either the membrane or a gas diffusion substrate. Additionally, electrode decals can be fabricated and then transferred to the membrane or gas diffusion backing layers. Methods for applying the electrocatalyst onto the substrate include spraying, painting, patch coating, slot die coating, and screen printing or flexographic printing. Preferably, the thickness of the anode and cathode electrodes ranges from about 0.1 to about 30 microns, more preferably less than 25 micron. The applied layer thickness is dependent upon compositional factors as well as the process used to generate the layer. The compositional factors include the metal loading on the coated substrate, the void fraction (porosity) of the layer, the amount of polymer/ionomer used, the density of the polymer/ionomer, and the density of any catalyst support. The process used to generate the layer (e.g. a hot pressing process versus a painted on coating or drying conditions) can affect the porosity and thus the thickness of the layer.

In a preferred embodiment, a catalyst coated membrane is formed wherein thin electrode layers are attached directly to opposite side of the membrane. In one method of preparation, the catalyst film is prepared as a decal by spreading the catalyst ink on a flat release substrate such as Kapton® polyimide film (available from the DuPont, Wilmington, Del.). The decal is transferred to the surface of the membrane by the application of pressure and optional heat, followed by removal of the release substrate to form a CCM with a catalyst layer having a controlled thickness and catalyst distribution. Alternatively, the electrocatalyst ink may be applied directly to the membrane, such as by printing, after which the catalyst film is dried at a temperature not greater than 200° C. The CCM, thus formed, can be combined with a gas diffusion backing substrate.

Another method is to first combine the catalyst ink of the invention with a gas diffusion backing substrate, and then, in a subsequent thermal consolidation step, with the membrane. This consolidation may be performed simultaneously with consolidation of the MEA at a temperature no greater than 200° C., preferably in the range of 140-160° C. The gas diffusion backing comprises a porous, conductive sheet material such as paper or cloth, made from a woven or non-woven carbon fiber, that can optionally be treated to exhibit hydrophilic or hydrophobic behavior, and coated on one or both surfaces with a gas diffusion layer, typically comprising a film of particles and a binder, for example, fluoropolymers such as PTFE. Gas diffusion backings for use in accordance with the present invention as well as the methods for making the gas diffusion backings are those conventional gas diffusion backings and methods known to those skilled in the art. Suitable gas diffusion backings are commercially available, including for example, Zoltek® carbon cloth (available from Zoltek Companies, St. Louis, Mo.) and ELAT® (available from E-TEK Incorporated, Natick, Mass.).

The membranes and electrodes formed from the dispersions described above can be homogeneously crosslinked by processes which form covalent bonds between the polymer pendant groups. One method comprises the addition of crosslinkable compounds to the dispersion used to form the membrane. These are defined herein as compounds with the potential to form crosslinks with the pendant SO₂X groups. The crosslinkable compounds can be also be formed in situ. The latter may be done by converting some or all of the polymer SO₂X groups to a functionality with the potential for reacting with additional or remaining SO₂X groups. Desirable crosslinkable compounds are at least bi-functional, with two or more potentially reactive groups, so that one group would react with one type of pendant group present on the polymer. Other potentially reactive groups on the crosslinkable compound would react with the same or different types of polymer pendant groups. Such crosslinkable compounds can also be added to the dispersion used to form the ionomer binder of one or more of the electrodes. Membranes manufactured and containing the crosslinkable compounds are then subjected to conditions favorable for crosslinking.

Suitable crosslinkable compounds include any molecule capable of facilitating bonding to two or more pendent groups and include, but are not limited to, ammonia, diamines, carboxyl amides, and sulfonamides. The crosslinks between polymer pendant groups typically comprise one or more sulfonimide (—SO₂NHSO₂—) crosslinks. In one embodiment, ammonia is added to the polymer dispersion as the crosslinkable compound so that 1% to 100% of the remaining pendant SO₂X groups are converted to pendant sulfonamide (SO₂NH₂) groups. The resulting dispersion may be blended with additional dispersion containing SO₂X groups and a membrane is manufactured by casting. A high temperature annealing step additionally facilitates anhydrous conditions within the membrane, which can be critical during crosslinking. The membrane and at least one adjoining electrode are then subjected to conditions which facilitate a crosslinking reaction between pendant SO₂X and SO₂NH₂ groups. Typically this is done by exposure to a compound capable of promoting the crosslinking reaction, which is known as a crosslinking promoter. Examples of crosslinking promoters include non-nucleophilic bases. Preferred crosslinking promoters are trialkylamine bases such as triethylamine, tripropylamine, tributylamine, and N,N,N′,N′-tetramethylethylenediamine. Temperatures at or near the boiling point of the trialkylamine base are desirable for crosslinking. By conducting crosslinking while the electrode and PEM are in intimate contact with each other, crosslinks are formed between the ionomer in the membrane and the ionomer in the electrode so as to chemically bind the electrode to the PEM.

In another embodiment, crosslinks between polymer pendant groups that contain more than one sulfonimide moiety can be achieved by the addition of a separate crosslinkable compound to the dispersion used to form the membrane and optionally to the dispersion used in forming at least one of the electrodes. The compound may contain additional sulfonimide groups and/or at least two sulfonamide groups. One suitable compound is of the formula HNR⁷SO₂R⁸SO₂NHR⁹, wherein R⁷ and R⁹ are independently hydrogen or optionally substituted alkyl groups, and R⁸ is a substituted or unsubstituted alkyl, a substituted or unsubstituted aryl, a substituted sulfonimide polymer, an ionene polymer, or a substituted or unsubstituted heteroatomic function. Addition of this compound would facilitate crosslinks containing a —SO₂NR⁷SO₂R⁸SO₂NR⁹SO₂— moiety. A desirable crosslink of this type is —SO₂NHSO₂(CF₂)₄SO₂NHSO₂—.

A crosslinked polymer membrane and electrode that still contains SO₂X groups can be converted to the sulfonate (SO₃⁻) form, which is sometimes referred to as ionic or ionomeric form, by hydrolysis using methods known in the art. For example, the membrane and electrode may be hydrolyzed to convert it to the sodium sulfonate form by immersing it in 25% by weight NaOH for about 16 hours at a temperature of about 90° C. followed by rinsing the film twice in deionized 90° C. water using about 30 to about 60 minutes per rinse. Another possible method employs an aqueous solution of 6-20% of an alkali metal hydroxide and 5-40% polar organic solvent such as DMSO with a contact time of at least 5 minutes at 50-100° C. followed by rinsing for 10 minutes. After hydrolyzing, the membrane and electrode can be converted if desired to another ionic form by contacting the membrane in a bath containing salt solution of the desired cation or, to the acid form, by contacting with an acid such as nitric acid and rinsing. For fuel cell use, the membrane is usually in the sulfonic acid form.

A fuel cell is constructed from a single MEA or multiple MEAs stacked in series by further providing porous and electrically conductive anode and cathode gas diffusion backings, gaskets for sealing the edge of the MEA(s), which also provide an electrically insulating layer, graphite current collector blocks with flow fields for gas distribution, aluminum end blocks with tie rods to hold the fuel cell together, an anode inlet and outlet for fuel such as hydrogen, a cathode gas inlet and outlet for oxidant such as air.

### EXAMPLE 1

### Dispersion Formation—Poly(PSEPVE-co-TFE)

52.3-g of poly(PSEPVE-co-TFE), which is a copolymer of tetrafluoroethylene (TFE) and perfluoro(3,6-dioxa-4-methyl-7-octenesulfonyl fluoride) (PSEPVE), having an equivalent weight of 647-g mol⁻¹ (80.8-mmol SO₂F) were cut into small pieces and placed in a dry 1-L 3-neck round bottom (RB) flask. The flask was fitted with mechanical stirring, heating mantle, a reflux condenser with nitrogen pad, and thermocouple. Approximately 185-mL of 2H-perfluoro(5-methyl-3,6-dioxanonane) (Freon® E2) was added and the polymer slowly dissolved over 0.5-h with stirring and heating to a gentle reflux. Heating was reduced and the solution cooled to between 50-70° C. Subsequent slow addition of 60-mL of N,N-dimethylformamide (DMF) by syringe (about 320-RPM stirring) resulted in a translucent mixture. A solution of 4.90-g (48.4-mmol) triethylamine (TEA), 1.74-g water (96.7-mmol), and about 20-mL of DMF was then added by syringe over 5-minutes. After 10 minutes, the mixture took on a white emulsion appearance. An additional 86-mL of DMF was added by syringe. The mixture was heated to about 80 to 90° C. with continued stirring (approximately 320-RPM) and held at temperature for about 1 hour (h). The reflux condenser was then replaced with a short path distillation apparatus. The emulsion was distilled at atmospheric pressure with a slow nitrogen sparge across the top of the still pot. Distillate was collected at a still head temperature that started at approximately 62° C. and climbed to approximately 79° C. for the duration of the distillation. The majority of the E2 was distilled off leaving a transparent and nearly colorless solution. Residual water was measured by Karl Fisher (KF) titration at about 230 PPM. Weight percent solids was measured by hot plate drying followed by vacuum oven drying (about 60° C., 29.5″-Hg) until constant weight was achieved and found to be 28.1%. A sample of the dispersion was diluted to approximately 5% (w/w) with acetone-d₆. A non-referenced ¹⁹F NMR of the 5% dispersion showed a remaining SO₂F peak at about 43.8-PPM (1 F, integral area=32.9) and a backbone CF peak at −139.9-PPM (1 F, integral area=100.0). Integral area calculations indicate that 67.1% of the SO₂F groups were hydrolyzed.

### EXAMPLE 2

### Dispersion Formation—Poly(PSEPVE-co-TFE)

50.1-g of a poly(PSEPVE-co-TFE) copolymer with a equivalent weight of 648-g mol⁻¹ (77.4-mmol SO₂F) were cut into small pieces and placed in a dry 500-mL 3-neck round bottom (RB) flask. The flask was fitted with mechanical stirring, heating mantle, and a reflux condenser with nitrogen pad. Approximately 175-mL of Freon® E2 was added and the polymer slowly dissolved with stirring and moderate heating (50-60° C.) in 1-2 hours. With 320-RPM stirring, 125-mL of DMF was slowly added by syringe. The mixture was homogeneous with up to about 80-mL of DMF. Further DMF addition afforded a white emulsion. 4.73-g (46.7-mmol) of TEA was then added by pipette followed by addition of about 1.85-g (103-mmol) of water. The emulsion was heated to a gentle reflux and held at temperature for about 1,5-h. Heating was reduced, and the emulsion cooled below reflux temperature. Mechanical stirring was replaced by magnetic stirring and the reflux condenser was replaced with a short path distillation apparatus. The mixture was distilled under vacuum (230-mmHg) at a temperature that started at about 55° C. and climbed to about 79° C. for the duration of the distillation. The majority of the E2 was distilled off leaving a transparent and nearly colorless solution. An additional 50-mL of E2 was added and distilled off under the previous conditions followed by an additional 25-mL of DMF to reduce viscosity. Residual water was measured by KF at about 300-PPM. Weight percent solids was measured by hot plate and subsequent vacuum oven drying (about 60° C., 29.5″-Hg) until constant weight was achieved and found to be 27.7-%. A sample of the dispersion was diluted to approximately 5% (w/w) with acetone-d₆. A non-referenced ¹⁹F NMR of the 5% dispersion showed a remaining SO₂F peak at about 43.8-PPM (1 F, integral area=35.7) and a backbone CF peak at −139.9-PPM (1 F, integral area=100.0). Integral area calculations indicate that 64.3-% of SO₂F groups were hydrolyzed.

### EXAMPLE 3

### Dispersion Formation—Poly(PFSVE-co-TFE)

45.0-g of a copolymer of 3-oxa-5-fluorosulfonylperfluoro-1-pentene and tetrafluoroethylene (poly(PFSVE-co-TFE)) with an equivalent weight of 600-g/mole (75-mmol SO₂F) are placed in a Parr 5100 high pressure reactor. The reactor is evacuated and 200-mL of 2H-perfluoro(5-methyl-3,6-dioxanonane) (Freon E2) are added to the reactor by cannula tubing. The reactor is re-evacuated and back filled with nitrogen (3 times) to 1 to 2 PSIG. The reactor is heated and maintained at 140° C. overnight as the polymer slowly dissolves. With 1100-RPM stirring, 26-mL of 10.0% (w/v) solution of triethylamine in DMF is pumped into the reactor using a Waters 515 HPLC pump. The solution also contains 2.7% (w/v) of water. After several minutes the mixture in the reactor takes on a white latex appearance and the copolymer eventually phase separates from the E2. Approximately 50 to 75-mL of DMF are then added to the reactor. Reactor heating is stopped. Stirring is then stopped when the reactor temperature decreases to ˜70° C. The reactor is vented to atmospheric pressure and the contents are transferred to a 1-L 3-neck RB flask. An additional 200-mL of DMF is used to rinse the reactor bomb and is added to the RB flask. The flask is fitted with mechanical stirring, heating mantle, short path distillation apparatus, and a gentle nitrogen sparge through one the necks. The majority of the E2 is distilled off at atmospheric pressure resulting in a homogenous transparent dispersion that is slightly yellow. Distillation is stopped when the dispersion temperature in the RB flask reaches ˜145° C. Once cooled to near ambient temperature, the dispersion percent solids is measured at ˜13.4% by drying a small sample in a petri dish with heating on a well-ventilated hot plate. The dispersion is transferred to a rotary evaporation flask and additional DMF is removed under vacuum (30-mmHg) to increase the percent solids to 20.5%. The dispersion is pressure filtered using ˜10-μm polypropylene filtration cloth. 226-g of dispersion is isolated. A small sample is diluted 4 times with acetone-d6 and submitted for 19F NMR analysis. The analysis indicates that 35% of the SO₂F groups are hydrolyzed. The effective equivalent weight, accounting for the triethylammonium cation, is calculated to be 635-g/mole.

### EXAMPLE 4

### Crosslinkable Agent Formation by Conversion of Dispersion SO₂F Groups to Sulfonamide (SO₂NH₂) Groups

91.8-g (1 2.8-mmol SO₂F) of the dispersion from Example 2 was placed in a dry 250-mL 3 neck RB flask fitted with mechanical stirring, a dry ice condenser with nitrogen pad, and gas addition port. The flask contents were chilled to about 5° C. using an ice water bath. 1.04-g (61.1-mmol) of ammonia was added using a mass flow integrator at a rate between 120 and 130-mg/min. The mixture turned cloudy as ammonia was added. The flask contents were stirred at the ice water bath temperature for 0.5-h. The bath was removed and the flask contents warmed to ambient temperature with stirring overnight. The dry ice condenser and the ammonia addition port were removed and replaced with a nitrogen pad adapter, a short path distillation apparatus, and a heating mantle. About 6-mL of TEA was added and the RB flask was heated with stirring and gentle nitrogen sparge to effect conversion of ammonium cations to triethylammonium cations. The cloudy dispersion turned transparent and was slightly yellow starting at around 70° C. Heating was stopped when no more residual TEA was observed to be collecting in the receiver flask. Weight percent solids were measured by vacuum oven drying (about 60 to 90° C., 29.5 inches-Hg) until constant weight was achieved and found to be 31.1%. The disappearance of remaining SO₂F groups and presence of SO₂NH₂ groups were confirmed by ¹⁹F NMR, and FTIR spectroscopy of a thin film cast from the dispersion. NH absorption centered at about 3200-cm⁻¹ and the disappearance of the remaining SO₂F absorption at about 1470-cm⁻¹ were confirmed.

### EXAMPLE 5

### Crosslinkable Agent Formation by Conversion of Dispersion SO₂F Groups to Sulfonamide (SO₂NH₂) Groups

75-g of the dispersion from Example 1 (9.71-mmol SO₂F) were placed in a dry 250-mL 3 neck RB flask fitted with mechanical stirring, a dry ice condenser with nitrogen pad, and ammonia addition port. The flask contents were chilled to about 5° C. using an ice water bath. 0.65-g (38.2-mmol) of ammonia was added using a mass flow integrator at a rate between 120 and 130-mg/min. The mixture turned cloudy as ammonia was added. The flask contents were stirred at the ice water bath temperature for 0.5-h. The bath was removed and the flask contents warmed to ambient temperature with stirring over 2 to 3-h. The dry ice condenser and the ammonia addition port were removed and replaced with a nitrogen pad adapter, a short path distillation apparatus, and a heating mantle. About 6-mL of TEA was added and the RB flask was heated with stirring and a gentle nitrogen sparge to effect conversion of ammonium cations to triethylammonium cations and remove ammonia and excess TEA. The cloudy dispersion turned transparent and slightly yellow starting at around 70° C. Heating was stopped when no more TEA was observed to be collecting in the receiver flask. Once cooled to ambient temperature, weight percent solids were measured by vacuum oven drying (about 60-90° C., 29.5 inches-Hg) until constant weight was achieved and found to be 28.3%. The disappearance of remaining SO₂F groups and presence of SO₂NH₂ groups were confirmed by ¹⁹F NMR, and FTIR spectroscopy of a thin film cast from the dispersion. NH absorption centered at about 3200-cm⁻¹ and the disappearance of the remaining SO₂F absorption at about 1470-cm⁻¹ were confirmed.

### EXAMPLE 6

### Crosslinkable Dispersion Formation by Addition of Bissulfonamide Crosslinker

100-g of the dispersion of Example 3 are placed in a 100-mL Pyrex® bottle followed by 1.37-g (3.59-mmol) of perfluorobutane-1,4-bissulfonamide monosodium salt (BBA). The BBA slowly dissolves with magnetic stirring and gentle heating. The dispersion with crosslinker is pressure filtered using ˜10-μm polypropylene filtration cloth into a clean 100-mL Pyrex® bottle.

### EXAMPLE 7

### Membrane Formation

A ˜15-μm thick microporous polytetrafluoroethylene (ePTFE) film is supported in a 10″ diameter embroidery hoop. The ePTFE film is sprayed with a 0.005-g/mL solution of the tripropylammonium salt of Zonyl® 1033D in ethanol. The ethanol is evaporated under a gentle nitrogen sparge. Next, a casting surface is prepared on which an 8 inch×10 inch piece of 2-mil Mylar® that is water tacked to an 8 inch×10 inch glass plate. The glass plate is supported on a 0.5 inch thick aluminum plate to form a casting surface assembly. The casting surface assembly is heated and maintained at ˜45° C. on a level hot plate surface. A doctor blade with an 8-mil gap is lined up at one end of the casting surface ˜0.5 inch from the end. Approximately 5-mL of the dispersion containing the crosslinker is placed in the gap of the doctor blade. The doctor blade is then drawn to the opposite end of the casting surface. The supported ePTFE is placed on top of the wet film and the dispersion quickly soaked into the ePTFE. The embroidery hoop is removed and a polypropylene cover is placed over the entire casting surface and heating assembly during film drying. A gentle nitrogen sparge is introduced into the cover to assist evaporation of DMF and make the assembly inert. After 30 minutes, a second 8-mil wet film thickness is added and the film is dried for an additional 30 minutes. The film with Mylar® attached is removed from the casting surface and annealed at 150° C. in a forced air oven for 2 minutes.

### EXAMPLE 8

### Electrode Decal Formation

208-g of DMF and 19.5-g of the above dispersion with the BBA crosslinker (Example 6) are placed in a 500-mL polypropylene screw cap bottle. 12.0-g of a 70% (w/w) finely dispersed platinum catalyst on carbon is slowly added. Ceramic mill beads are added and the bottle is tightly capped and roll-milled for 12 hours, resulting in finely dispersed catalyst ink. An 8″×10″ and 2-mil thick Mylar® shim with a 2 inch×2 inch area cut from the center is water tacked to the Mylar® surface of the casting assembly described in Example 6. Approximately 0.5-mL of the catalyst ink is placed in the cut out area of the shim along one edge. A casting knife with a 0-mil gap is used to draw the ink evenly within the cut out area. The polypropylene cover is put in place and the decal is dried for one hour under a gentle nitrogen sparge. The shim is removed leaving a 2 inch×2 inch square catalyst decal on Mylar®. The Mylar® is trimmed to a 6 inch×6 inch square with the decal in the center. The platinum catalyst loading is measured at 0.4-mg/cm² by x-ray fluorescence. The process is repeated to produce multiple electrode decals.

### EXAMPLE 9

### Mea Assembly

The membrane of Example 6 is trimmed to a 6 inch×6 inch square and gently removed from the Mylar® backing. The film is placed within an 8 inch×8 inch stainless steel support frame and held in place using constant tension and spring-loaded support clips that are spaced along the inside edge of the frame. The membrane film is then re-annealed in a forced air oven at 150° C. for 2 minutes. An electrode decal of Example 7 is centered on a 0.25″ thick, 4 inch×4 inch aluminum hot press platen that is itself centered on a 0.125″ thick, 8 inch×8 inch aluminum hot press platen. The film in the frame is centered over the platen assembly. A second catalyst decal and a 4 inch×4 inch platen are centered on top of the film and the whole platen assembly is placed in a hot press. The assembly is pressed at 150° C. and a pressure of 1000-PSIG for 4 minutes. On cooling to ambient temperature, the Mylar® backings are gently peeled from the un-crosslinked 3-layer MEA

### EXAMPLE 10

### Mea Crosslinking, Hydrolysis and Acid Exchange

A membrane crosslinking apparatus is assembled and consists of a 12″ ID shallow kettle with lid, and a set of clamping rings to hold them together. The kettle lid is fitted with a reflux condenser and the apparatus is made inert and kept dry using a dry nitrogen sparge connected to the top of the condenser. A 1 to 1.5 inch high×11 inch diameter tapered support ring made from 0.125 inch thick stainless steel is placed in the kettle. Tripropylamine, to a depth of 0.25 to 0.5 inch, and lithium hydride powder (2 to 5-g) are added to the kettle.

The 3-layer MEA of Example 8, which is still in the support frame, is heated in the forced air oven at 150° C. for 2 minutes. The MEA is then quickly transferred from the oven onto the support ring in the kettle, and the kettle is sealed with the clamping rings. The kettle is heated on a hot plate and is maintained at a temperature where the tripropylamine gently refluxes. Heating is discontinued after 30 minutes and the kettle is allowed to cool to near ambient temperature. The crosslinked MEA is then transferred from the kettle to a hydrolysis bath which contains 15% (w/w) aqueous KOH at ˜80° C. for 30 minutes. The MEA is then rinsed repeatedly with deionized water. The MEA is then soaked in 2-M nitric acid with gentle agitation on a shaker table for 10 minutes. The MEA is again rinsed repeatedly with deionized water and then immersed in bath containing 35% nitric acid at reflux temperature for 30 minutes. The MEA is then rinsed repeatedly with deionized water, and the treatment with 2-M nitric acid is repeated. The MEA is rinsed repeatedly with 18-M demonized water and dried in the forced air oven at 150° C. for 2-4 minutes. The dry and active MEA is removed from the support frame and trimmed to 4 inch×4 inch.

What is claimed is:

1. A membrane electrode assembly comprising:
a) a proton exchange membrane comprised of a first polymer having a fluorinated backbone containing pendant groups described by the formula —(O—CF₂CFR_{f})ₐ—(O—CF₂)_{b}—(CFR′_{f})CSO₂X, where X is a halogen, an —OH or salt thereof, and R_{f} and R′_{f} are independently selected from F, Cl or a perfluorinated alkyl group having 1 to 10 carbon atoms, a=0 to 2, b=0 to 1, and c=0 to 6; and
b) an electrode comprised of an electrocatalyst and a second polymer having a fluorinated backbone containing pendant groups described by the formula —(O—CF₂CFR_{f})ₐ—(O—CF₂)_{b}—(CFR′_{f})_{c}SO₂X, where X is a halogen, an —OH or salt thereof, and R_{f} and R′_{f} are independently selected from F, Cl or a perfluorinated alkyl group having 1 to 10 carbon atoms, a=0 to 2, b=0 to 1, and c=0 to 6, wherein the electrode is positioned against the membrane and is crosslinked to the membrane.

2. The membrane electrode assembly of claim 1 wherein there are crosslinks between pendant groups of the first polymer in the membrane and pendant groups of the second polymer in the electrode.

3. The membrane electrode assembly of claim 2 wherein the crosslinks comprise one or more sulfonimide moieties.

4. The membrane electrode assembly of claim 3 wherein the sulfonimide moieties comprise SO₂NR⁷SO₂R⁸SO₂NR⁹SO₂ crosslinks, wherein R⁷ and R⁹ are independently hydrogen or optionally substituted alkyl groups, and R⁸ is a substituted or unsubstituted alkyl, a substituted or unsubstituted aryl, a substituted sulfonimide polymer, an ionene polymer, or a substituted or unsubstituted heteroatomic function.

5. The membrane electrode assembly of claim 3 wherein the sulfonimide moieties comprise SO₂NHSO₂ crosslinks.

6. The membrane electrode assembly of claim 1 wherein the first polymer comprises pendant groups of the formula —O—CF₂CF(CF₃)—O—CF₂CF₂SO₂X or —OCF₂CF₂SO₂X, or any combination thereof.

7. The membrane electrode assembly of claim 1 wherein the first polymer is highly fluorinated and wherein the second polymer is highly fluorinated.

8. The membrane electrode assembly of claim 7 wherein the first polymer and the second polymer are the same polymer.

9. The membrane electrode assembly of claim 1 wherein the first polymer is perfluorinated and wherein the second polymer is perfluorinated.

10. The membrane electrode assembly of claim 2 wherein there are crosslinks between pendant groups of the first polymer within the membrane.

11. The membrane electrode assembly of claim 10 wherein the crosslinks comprise one or more sulfonimide moieties.

12. The membrane electrode assembly of claim 11 wherein the sulfonimide moieties comprise SO₂NR⁷SO₂R⁸SO₂NR⁹SO₂ crosslinks, wherein R⁷ and R⁹ are independently hydrogen or optionally substituted alkyl groups, and R⁸ is a substituted or unsubstituted alkyl, a substituted or unsubstituted aryl, a substituted sulfonimide polymer, an ionene polymer, or a substituted or unsubstituted heteroatomic function.

13. The membrane electrode assembly of claim 11 wherein the sulfonimide moieties comprise SO₂NHSO₂ crosslinks.

14. The membrane electrode assembly of claim 1 wherein the electrode is adhered to a gas diffusion layer and to the membrane.

15. The membrane electrode assembly of claim 1 wherein a porous support substrate is incorporated into said membrane, and wherein the first polymer substantially fills the pores of the porous substrate and crosslinks are formed between pendant groups of the first polymer within the pores of the porous substrate.

16. A membrane electrode assembly comprising:
a) a proton exchange membrane having opposite first and second sides, said membrane comprised of a first polymer having a fluorinated backbone containing pendant groups described by the formula —(O—CF₂CFR_{f})ₐ—(O—CF₂)_{b}—(CFR′_{f})_{c}SO₂X, where X is a halogen, an —OH or salt thereof, and R_{f} and R′_{f} are independently selected from F, Cl or a perfluorinated alkyl group having 1 to 10 carbon atoms, a=0 to 2, b=0 to 1, and c=0 to 6;
b) an anode electrode positioned against the first side of the membrane, said anode electrode comprised of an electrocatalyst and a second polymer having a fluorinated backbone containing pendant groups described by the formula —(O—CF₂CFR_{f})ₐ—(O—CF₂)_{b}—(CFR′_{f})_{c}SO₂X, where X is a halogen, an —OH or salt thereof, and R_{f} and R′_{f} are independently selected from F, Cl or a perfluorinated alkyl group having 1 to 10 carbon atoms, a=0 to 2, b=0 to 1, and c=0 to 6, wherein crosslinks are formed between the pendant groups of the first polymer in the membrane and the pendant groups in the second polymer of said anode electrode; and
c) an cathode electrode positioned against the second side of the membrane, said anode electrode comprised of an electrocatalyst and a third polymer having a fluorinated backbone containing pendant groups described by the formula —(O—CF₂CFR_{f})ₐ—(O—CF₂)_{b}—(CFR′_{f})_{c}SO₂X, where X is a halogen, an —OH or salt thereof, and R_{f} and R′_{f} are independently selected from F, Cl or a perfluorinated alkyl group having 1 to 10 carbon atoms, a=0 to 2, b=0 to 1, and c=0 to 6, wherein crosslinks are formed between the pendant groups of the first polymer in the membrane and the pendant groups in the third polymer of said cathode electrode.

17. The membrane electrode assembly of claim 16 wherein the crosslinks formed between the pendant groups of the first polymer in the membrane and the pendant groups in the second polymer of said anode electrode comprise one or more sulfonimide moieties, and wherein the crosslinks formed between the pendant groups of the first polymer in the membrane and the pendant groups in the third polymer of said cathode electrode comprise one or more sulfonimide moieties.

18. The membrane electrode assembly of claim 17 wherein the sulfonimide moieties comprise SO₂NHSO₂ crosslinks.

19. The membrane electrode assembly of claim 17 wherein the sulfonimide moieties comprise SO₂NR⁷SO₂R⁸SO₂NR⁹SO₂ crosslinks, wherein R⁷ and R⁹ are independently hydrogen or optionally substituted alkyl groups, and R⁸ is a substituted or unsubstituted alkyl, a substituted or unsubstituted aryl, a substituted sulfonimide polymer, an ionene polymer, or a substituted or unsubstituted heteroatomic function.

20. The membrane electrode assembly of claim 17 wherein a porous support substrate is incorporated into said membrane, and wherein the first polymer substantially fills the pores of the porous substrate and crosslinks are formed between pendant groups of the first polymer within the pores of the porous substrate.
